(19) United States
(12) Patent Application Publication
(10) Pub. No.: US 2013/0268349 A1
(43) Pub. Date: Oct. 10, 2013

(54) METHOD AND SYSTEM OF OPTIMIZING A MARKETING CAMPAIGN OF A SALABLE COMMODITY

(71) Applicant: CORELOGIC, Irvine, CA (US)

(72) Inventors: Artak AMIRBEKYAN, Brisbane (AU); Gregory John DICKASON, Brisbane (AU)

(21) Appl. No.: 13/790,972

(22) Filed: Mar. 8, 2013

(30) Foreign Application Priority Data
Mar. 9, 2012 (AU) 2012900940

(51) Int. Cl. G06Q 30/02; G06Q 50/16

(52) U.S. Cl. CPC G06Q 30/0244; G06Q 50/16
USPC 705/14.43

(57) ABSTRACT

Embodiments of the present invention may allow selling agents to create a marketing campaign analysis, and associated marketing campaign recommendations, for a prospective seller of a saleable in an interactive fashion with the prospective seller. Embodiments of the present invention may utilize historical marketing and/or sales data for comparable properties (that have either been sold or for which sale has, or is currently, being attempted) in order to identify successful advertising campaigns. The relative ‘success’ of an advertising campaign can be determined by reference to certain predefined performance metrics. Based upon the results of these performance metrics (which can be customized to meet a seller's desired selling strategy), embodiments of the present invention may allow a selling agent to present the seller with one or more optimized marketing campaigns, from which a final marketing campaign can be selected for the listing of the subject property.

### CROSS-REFERENCE TO RELATED APPLICATIONS

This application claims the benefit of priority from prior Australian (AU) Application No. 2012900940, filed Mar. 9, 2012, entitled “METHOD AND SYSTEM OF OPTIMIZING A MARKETING CAMPAIGN OF A SALABLE COMMODITY,” the entire contents of which are incorporated herein by reference in its entirety.

### BACKGROUND

1. Field

The present disclosure relates generally to computerized information systems. In particular, the present disclosure concerns a method and system of optimizing a marketing campaign for a saleable commodity. The present disclosure may be particularly useful in relation to optimizing a marketing campaign for a real estate property. However, it should be understood that embodiments of the present invention may be implemented in other environments.

2. Description of the Related Art

When selling an item of property, such as a home, a boat, a plane, artwork, a luxury car or the like, it can be usual for the owner of the property to engage an agent or broker to assist with the sale process, including the formulation of a marketing campaign (e.g. a series of sales advertisements) to achieve the successful sale of the property. Some of the important decisions when selling a saleable commodity can be:

Should I have a listing price and, if so, what should that price be?

What marketing should take place?

Which agent or broker should I use?

The answers to these questions may often determine the success or failure of the sales process for the owner of the saleable commodity. The following information can relate to the sale of real property (such as a house, apartment, office building, warehouse, shopping center and the like), but can also equally applicable to the sale of other saleable commodities where a broker or agent is engaged to assist the vendor in the sale process, including the formulation of a suitable marketing/advertising campaign.

It is becoming increasingly popular for vendors to use real estate agents for listing and selling a property. A typical property may be a house or apartment. The real estate agent (or listing agent) can be engaged by the vendor (e.g., the owner who is the seller of the property) to find potential buyers for the property and assist in the negotiation of a contract of sale for the property. Typically, a real estate agent can enter into a contract with the vendor of the property whereby the vendor appoints the real estate agent as the exclusive listing agent for the property for a period of time (e.g. for two months). When the property is sold, the real estate agent is paid a commission by the vendor. Thus, it is important for successful real estate agents to sign up vendors and be appointed as the selling agent for the property.

Typically, a real estate agent may prepare a sales pitch and a competitive market analysis (CMA) to show potential vendors, e.g., property owners who have expressed an interest in selling a property. When working with sellers to determine a listing price, real estate agents may do what is known as a comparative market analysis, or CMA. By going to sold property records, the real estate professional selects recently sold properties that are similar to the subject property and in the same area. By comparing these properties, and adjusting for feature differences, an estimate of value is made for the subject property.

Based on research conducted by the inventors, agents may spend varied time preparing for each listing appointment, typically from 30 minutes to more than 2 hours, depending on the property. Agent's individual approach to obtaining a listing can vary greatly, and the amount of information agents provide vendors during a listing may vary on each vendor type and property type. Prospective vendors may typically ask a potential listing agent questions such as. “How much do you think my property is worth?” and “How much is it going to cost me to sell it?” and “What advertising strategies should be used?” and “How long will it take to sell my property?”

The real estate agent, upon appointment as the selling agent for the property, may generally present the vendor with one or more marketing plans or campaigns, which outline various options for the potential advertising of the property. Once the vendor and agent have agreed upon a suitable marketing campaign for the property, the agent may typically require the vendor to pay for the proposed campaign up front, and without any guarantee that the selected marketing campaign will result in the successful sale of the property.

The marketing options typically presented to a vendor by a selling agent, as part of a marketing plan, can include one or more:

print advertising in various newspapers, magazines, and real estate publications, generally with professional color photographs of the listed real estate property;

online Internet advertising on various real estate websites and listing portals;

brochures, emails and mail-outs;

premium listings, such as full page newspaper advertisements or first ranking search results for Internet listing portals;

window displays in the agents office;

open houses;

having the property professionally styled;

determining the type of sale (e.g., auction, tender, private treaty); and

If sale by auction is chosen by the vendor, a marketing plan designed to generate interest and attract bidders and buyers on the day of the auction will be required.

In addition to the marketing campaign, the vendor's primary concerns often may relate to the listing price of the real estate property and the estimated time for the real estate agent to sell the property. In relation to both of these factors, the vendor may often be guided by the real estate agent who has specific market knowledge of the area in which the real estate property is located. However, demand can be often difficult to accurately predict, and vendors can become disappointed if the listing price is not realized at sale, or if the property remains on the market for an extended period of time. In some cases, this may be partly attributable to an unrealistic listing price being set by the vendor. If a property does not sell, it can usually because of two factors—the listing price being too high and/or a poor marketing campaign that does not attract the right potential purchasers.

Some of the important questions typically asked by a vendor, during the selection of a marketing campaign, may include:

Given the geographical area in which my property is located, what type(s) of advertisements should be used in the marketing campaign?

Does the most effective marketing campaign depend upon the type of property that I am trying to sell?

Should I advertise the property online, in print, or a combination of both?

Given a particular combination of advertisement types in my marketing campaign, approximately how long will it take to sell my property?

Given a particular combination of advertisement types in my marketing campaign, what percentage discount on my initial asking price am I likely to concede in order to sell the property?

In relation to choosing a suitable marketing campaign, that will attract the right purchasers and result in the successful sale of the property, the majority of vendors can be guided by the selling agent. In this regard, it is somewhat expected that the selling agent may have the necessary expertise, and/or local sales experience, required to make informed recommendations regarding the most appropriate marketing campaign. However, this is not always the case and a lack of relevant sales experience, for example, in addition to external or unforeseen factors, can often result in the selection of an unsuitable and therefore ultimately ineffective marketing campaign. As a result, the agent may fail to sell the property in a timely manner or, alternatively, the vendor may be required to significantly discount the initial asking price in order to achieve a sale.

In view of these limitations, there is a need for an improved method of optimizing a marketing campaign for a property.

There is also a need for a tool for real estate agents to allow the agent to make informed recommendations regarding the composition of a proposed marketing campaign, based upon actual marketing and sales data for other properties within a given relevant geographic area. Ideally, such a tool can also enable the vendor to make an informed decision regarding the level of marketing expenditure required, on a marketing campaign, in order to achieve the successful and timely sale of their property.

In general, there is a need for a tool for selling agents or brokers to assist the agent/broker gain listings of saleable commodities (such as, for example, boats, artwork and the like), and further, where the tool assists the agent/broker and the vendor of the saleable commodity to determine and agree on the composition of a suitable marketing campaign in order to maximize the sale price and minimize the time taken to sell the saleable commodity, and determine and agree on a listing price for the saleable commodity.

In this specification where a document, act or item of knowledge is referred to or discussed, this reference or discussion is not an admission that the document, act or item of knowledge or any combination thereof was at the priority date, publicly available, known to the public, part of the common general knowledge; or known to be relevant to an attempt to solve any problem with which this specification is concerned.

### SUMMARY

Embodiments of the present invention may allow selling agents to create a marketing campaign analysis, and associated marketing campaign recommendations, for a prospective seller of a saleable commodity (such as, for example, a real estate property) in an interactive fashion with the prospective seller, taking into account the feedback of the seller in real time.

In a representative embodiment, the marketing campaign analysis and recommendations can be produced on a portable computing device, such as an Apple iPad, that has a wireless connection to the Internet. A real estate agent can sit with the prospective seller, and both the agent and the prospective seller can look at the screen of the portable computing device at the same time, and make decisions jointly. Embodiments may then produce, and make available to the agent and the prospective seller, a marketing campaign analysis that both believe includes representative comparable properties (that have either been sold or for which sale has, or is currently, being attempted) and includes rankings of advertising campaigns that have been used for those comparable properties. Thus, the marketing campaign analysis and resultant selection of an optimized marketing campaign for the subject property may be more likely to result in the successful and timely sale of the subject property, and therefore the prospective seller is more likely to appoint that agent as the selling agent.

Embodiments of the present invention may utilize historical marketing and/or sales data for comparable properties (that have either been sold or for which sale has, or is currently, being attempted) in order to identify successful advertising campaigns. The relative ‘success’ of an advertising campaign can be determined by reference to certain predefined performance metrics. Based upon the results of these performance metrics (which can be customized to meet a seller's desired selling strategy), embodiments of the present invention may allow a selling agent to present the seller with one or more optimized marketing campaigns, from which a final marketing campaign can be selected for the listing of the subject property. Preferably, the selection of marketing campaign, and associated advertising campaign, is agreed upon by both the selling agent and the seller.

According to an aspect of one or more embodiments of the present invention, there is provided a computer-implemented method of optimizing a marketing campaign of a saleable commodity, said method comprising:

(a) receiving from a user one or more descriptors relating to said saleable commodity;

(b) identifying based on said one or more descriptors comparable saleable commodities for which marketing has been conducted;

(c) retrieving marketing data and/or sales data corresponding to said one or more comparable saleable commodities, said marketing data including advertising selections used in the sale or attempted sale of said one or more comparable saleable commodities;

(d) aggregating said comparable saleable commodities into one or more advertising campaigns based upon said advertising selections;

(e) calculating for each of said advertising campaigns performance data based upon said marketing data and/or said sales data;

(f) ranking based on said performance data the success of said one more advertising campaigns according to one or more predefined performance metrics;

(g) assigning a marketing campaign to said saleable commodity based on the ranking of said one more advertising campaigns, said marketing campaign including a selection of said advertising selections.

The method may be particularly useful in relation to optimizing a marketing campaign for the sale of a real estate property. However, it should be understood that the method could equally be used for optimizing a marketing campaign for the sale of goods such as, for example, luxury automobiles or boats, items of jewelry, antiques, paintings, artwork and the like, where a broker or agent is engaged to assist the vendor in the sale process, including the formulation of a suitable marketing/advertising campaign.

In the embodiment described below, the saleable commodity is a real estate property, such as a residential or commercial property, and the comparable saleable commodities are comparable real estate properties.

The one or more descriptors include at least a geographical region in which the real estate property is located, and may include the street, suburb (e.g. postcode), and/or state in which the property is located. In addition, the descriptors may also include a property type classification such as, for example, house, apartment, unit, villa, townhouse and land. Further descriptors may also include more specific property features such as, for example, number of bedrooms, number of bathrooms, permitted land use, land size, property type, age of property, parking (e.g., garage or carport, and number of spaces), internal floor area, number of levels, level in the building and the like.

For each of the comparable real estate properties, the marketing data may include one or more of an initial listing price for the comparable real estate property, a date on which the comparable real estate property was first listed for sale, and advertising selections used in the sale or attempted sale of the comparable real estate property.

For each of the comparable real estate properties, the advertising selections may include one or more of a specific print medium (e.g. Can berra Times), a specific radio medium (e.g. 3AW Radio Station), a specific television medium (e.g. Channel 7), and a specific online medium (e.g. realestate.com.au). As previously indicated, the aggregation of the comparable real estate properties into one or more advertising campaigns may be based on the advertising selections for each of said comparable real estate properties. In this regard, the advertising campaigns may comprise individual advertising selections and/or combinations of advertising selections (e.g. advertising campaigns for which advertisements were placed in Can berra Times, and on realestate.com.au).

For each of the comparable real estate properties, the sales data for each of the comparable real estate properties may include one or more of a final sale price at which the comparable real estate property was sold, a date on which the comparable real estate property was sold, and a sale status.

The performance data calculated for each of the comparable real estate properties may include one or more:

(a) the sales success rate for each of the advertising campaigns, which may be calculated by comparing the total number of comparative real estate properties sold and the total number of comparative real estate properties advertised for sale;

(b) the frequency of advertising campaigns, which may be calculated by counting the number of comparable real estate properties, and/or the specific advertising formats (e.g. small advertisement for print media, premium listing for online media), for a given advertising campaign;

(c) the average time on market prior to sale, which may be calculated as the average time between the listing date and sales date for all comparable real estate properties within a given advertising campaign; and

(d) the average vendor discount of initial listing price relative to final sale price, which may be calculated as the average vendor discount on the listing price for all comparable real estate properties within a given advertising campaign.

The predefined performance metrics used to rank the success of the advertising campaigns may include one or more of:

(a) highest sales success rate, which would preferably involve ranking all advertising campaigns according to the performance data for sales success rate;

(b) least time on market prior to sale, which would preferably involve ranking all advertising campaigns according to the performance data for average time on market prior to sale;

(c) most popular advertising campaign, which would preferably involve ranking all advertising campaigns according to the performance data for frequency of advertising campaign; and

(d) least vendor discount on initial listing price relative to final sale price, which would preferably involve ranking all advertising campaigns according to the performance data for average vendor discount.

It should be appreciated that additional performance metrics could also be used to rank the advertising campaigns, and that one or more or more of the above described performance metrics may be excluded (when conducted a marketing campaign analysis for given real estate property) depending on the specific marketing campaign strategy desired by the real estate agent and/or vendor.

In addition, step (g) may further include the preliminary step of presenting to the user one or more marketing campaigns in relation to listing said real estate property for sale. Preferably, each of said marketing campaigns comprises a different combination of advertising selections.

In one embodiment of the present invention, the method can include the further step of receiving from a vendor an authority to list the real estate property for sale, said authority to list including confirmation of a selected marketing campaign offer and/or a listing price for said real estate property.

According to a further aspect, there is provided a computer-implemented system of optimizing a marketing campaign of a saleable commodity, said system comprising:

(a) means for receiving from a user one or more descriptors relating to said saleable commodity;

(b) means for identifying based on said one or more descriptors comparable saleable commodities for which marketing has been conducted;

(c) means for retrieving marketing data and/or sales data corresponding to said one or more comparable saleable commodities, said marketing data including advertising selections used in the sale or attempted sale of said one or more comparable saleable commodities;

(d) means for aggregating said comparable saleable commodities into one or more advertising campaigns based upon said advertising selections;

(e) means for calculating for each of said advertising campaigns performance data based upon said marketing data and/or said sales data;

(f) means for ranking based on said performance data the success of said one more advertising campaigns according to one or more predefined performance metrics;

(g) means for assigning a marketing campaign to said saleable commodity based on the ranking of said one more advertising campaigns, said marketing campaign including a selection of said advertising selections.

Preferably, the saleable commodity is a real estate property, such as a residential or commercial property, and the comparable saleable commodities are comparable real estate properties.

According to a still further aspect, there is provided a computer-implemented system of optimizing a marketing campaign of a saleable commodity, said system comprising one or more computers including:

at least one processor;

an interface between said processor and a data network;

a database for containing information relating to said saleable commodity; and

at least one storage medium operatively coupled to said processor, said storage medium containing program instructions for execution by said processor, said program instructions causing said processor to execute the steps of:

(a) receiving from a user one or more descriptors relating to said saleable commodity;

(b) identifying based on said one or more descriptors comparable saleable commodities for which marketing has been conducted;

(c) retrieving from said database marketing data and/or sales data corresponding to said one or more comparable saleable commodities, said marketing data including advertising selections used in the sale or attempted sale of said one or more comparable saleable commodities;

(d) aggregating said comparable saleable commodities into one or more advertising campaigns based upon said advertising selections;

(e) calculating for each of said advertising campaigns performance data based upon said marketing data and/or said sales data;

(f) ranking based on said performance data the success of said one more advertising campaigns according to one or more predefined performance metrics;

(g) storing in said database information relating to said saleable commodity, said comparable saleable commodities, and/or said rank of said advertising campaigns; and

(g) assigning a marketing campaign to said saleable commodity based on the ranking of said one more advertising campaigns, said marketing campaign including a selection of said advertising selections.

Preferably, the saleable commodity is a real estate property, such as a residential or commercial property, and the comparable saleable commodities are comparable real estate properties.

According to a still further aspect, there is provided a tangible computer-readable medium having computer-executable instructions stored thereon for performing a method of optimizing a marketing campaign of a saleable commodity, said method comprising:

(a) receiving from a user one or more descriptors relating to said saleable commodity;

(b) identifying based on said one or more descriptors comparable saleable commodities for which marketing has been conducted;

(c) retrieving marketing data and/or sales data corresponding to said one or more comparable saleable commodities, said marketing data including advertising selections used in the sale or attempted sale of said one or more comparable saleable commodities;

(d) aggregating said comparable saleable commodities into one or more advertising campaigns based upon said advertising selections;

(e) calculating for each of said advertising campaigns performance data based upon said marketing data and/or said sales data;

(f) ranking based on said performance data the success of said one more advertising campaigns according to one or more predefined performance metrics;

(g) assigning a marketing campaign to said saleable commodity based on the ranking of said one more advertising campaigns, said marketing campaign including a selection of said advertising selections.

According to a still further aspect, there is provided a computer-implemented method to assist a selling agent obtain a listing for a property to be sold by a vendor of the property, the selling agent and the vendor located at a remote computer, said method comprising:

(a) at a remote computer, inputting one or more descriptors to identify the property to be sold;

(b) retrieving from a central database marketing data and/or sales data of comparable properties to the property to be sold based on said one or more descriptors, said marketing data including one or more advertising options used in the sale or attempted sale of said one or more comparable properties;

(c) aggregating the comparable properties into one or more advertising campaigns based upon said advertising options;

(d) at the remote computer, receiving from the vendor and/or selling agent a selection of preferred performance metrics to rank said advertising campaigns;

(e) providing to a central computer the selection of preferred performance metrics;

(f) at the central computer, using the selection of preferred performance metrics to rank the success of said advertising campaigns;

(g) providing to the remote computer at least a top ranking advertising campaign for each of the preferred performance metrics;

(h) displaying to a vendor at the remote computer the top ranking advertising campaign for each of the preferred performance metrics.

The method may also comprise the further steps of:

(a) displaying, to the vendor at the remote computer, a plurality of marketing campaign offers, said marketing campaign offers being based upon the top ranking advertising campaign for each of the preferred performance metrics; and

(b) selecting one of said marketing campaign offers at the remote computer.

The method may also comprise the further steps of:

(a) displaying, to the vendor at the remote computer, an authority for the selling agent to act for the vendor; and

(b) at the remote computer, the vendor signifying acceptance of the authority to act,

wherein said authority includes confirmation of a selected marketing campaign offer and/or a list price agreed between the vendor and the selling agent.

According to a still further aspect, there is provided a computer-implemented method of optimizing a marketing campaign for the sale of a residential property, said method comprising:

(a) receiving one or more descriptors relating to the residential property;

(b) identifying, based on said one or more descriptors, at least one comparable residential property for which marketing to sell said comparable residential property has been conducted;

(c) retrieving historical marketing data and sales data corresponding to each comparable residential property, said marketing data including advertising selections used in the sale or attempted sale of said comparable residential property; and

(d) identifying, using said marketing data and sales data, the most effective advertising campaign for said residential property.

Details of one or more implementations of the subject matter described in this specification are set forth in the accompanying drawings and the description below. Other features, aspects, and advantages will become apparent from the description, the drawings, and the claims.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure. In the drawings:

FIG. 1 shows a schematic block diagram of a system of optimizing a marketing campaign of a real estate property in accordance with a representative embodiment of the present invention.

FIG. 2 is a flow chart illustrating a method of optimizing a marketing campaign of a real estate property in accordance with one embodiment of the present invention.

FIGS. 3 and 4 illustrate examples of a report generation screen produced using the marketing campaign analysis application and a multi-locational report generation screen respectively.

### DETAILED DESCRIPTION

Various aspects of the disclosure will now be described with regard to certain examples and embodiments, which are intended to illustrate but not to limit the disclosure.

Representative embodiments of the present invention relate to a computer implemented method and system of optimizing a marketing campaign of a saleable commodity. Embodiments of the invention is particularly useful in relation to optimizing a marketing campaign of a real estate property and it will therefore be convenient to describe the embodiments in that environment. However, it should be understood that embodiments of the invention are not limited, and may be implemented in other environments.

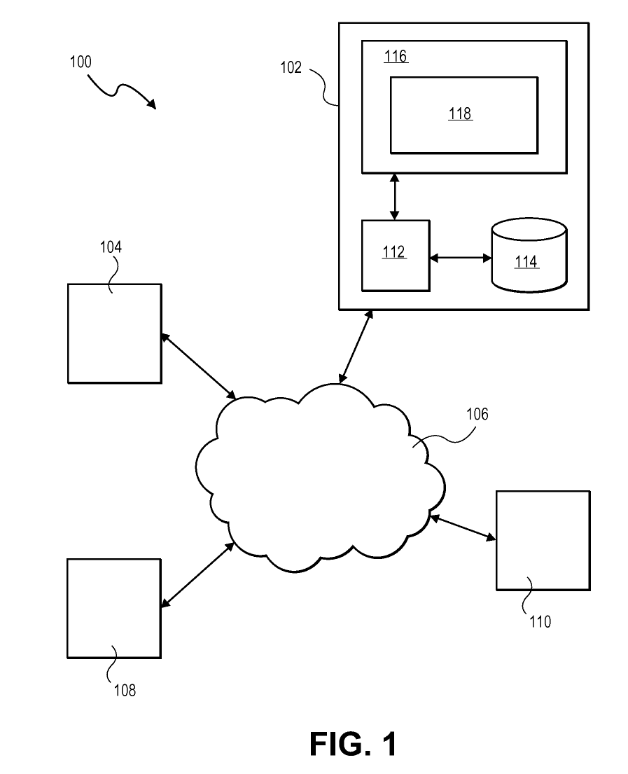

FIG. 1 illustrates an system 100 in which one or more embodiments of the present invention may be implemented. The system can include a server 102 and at least one user terminal 104, both of which are connected to a network 106, which may be, for example, the Internet. Also connected to the network 106 are a plurality of user terminals and/or servers, e.g. 108, 110. It will be appreciated that FIG. 1 depicts the system 100 schematically only, and is not intended to limit the technology employed in the servers, user terminals and/or communication links. The user terminals in particular may be wired or wireless devices, and their connections to the network may utilize various technologies and bandwidths. For example, applicable user terminals can include (without limitation): PC's with wired (e.g. LAN, cable, ADSL, dial-up) or wireless (e.g. WLAN, cellular) connections; and wireless portable/handheld devices such as PDA's, Apple iPads, or mobile/cellular telephones and smartphones. These devices also may include input means, such as a mouse and keyboard, stylus or other pointing device or system, or a touch screen, to enable the users to make selections and input data. The protocols and interfaces between the user terminals and the servers may also vary according to available technologies, and include (again without limitation): wired TCP/IP (Internet) protocols; GPRS, WAP and/or 3G protocols (for handheld/cellular devices); Short Message Service (SMS) messaging for digital mobile/cellular devices; and/or proprietary communications protocols.

The server 102 may include at least one processor 112 as well as a database 114, which can typically be stored on a secondary storage device of the server 102, such as one or more hard disk drives. Server 102 can further include at least one storage medium 116, typically being a suitable type of memory, such as random access memory, for containing program instructions and transient data related to the operation of the valuation system as well as other necessary functions of the server 102. In particular, memory 116 can contain a body of program instructions 118 implementing the method and system in accordance with embodiments of the invention. The body of program instructions 118 may include instructions for optimizing a marketing campaign of a real estate property, the operation of which will be described hereafter.

It should be appreciated that the hardware used may be conventional in nature or specifically designed for the purpose. The hardware structure shown in FIG. 1 is merely one possible embodiment and any other suitable structure may be utilized.

As discussed above, in relation to the sale of real estate property, it can be usual for the owner of the property to engage an agent or broker to assist with the sale process, including the formulation of a marketing campaign (e.g. a series of sales advertisements) to achieve the successful sale of the property. A potential vendor of a real estate property may often telephone or email a selection of real estate agents, and ask each real estate agent to make a proposal to the vendor about selling the vendor's property. Prior to an appointment with the potential vendor, it may be usual for the agent to prepare a CMA to present to the vendor, along with one or more marketing plans (including proposed advertising campaigns) for the property, and the commissions and costs that the agent will charge the vendor.

In accordance with a representative embodiment of the present invention, method and system of optimizing a marketing campaign of a real estate property may include the analysis of marketing and/or sales data (both current and historical), that is available for comparable real estate properties, in order to perform a marketing campaign analysis. Such data can be preferably stored within a centralized database 114. In order for the results of the marketing campaign analysis to be accurate, it should be understood that such a database may contain a suitable volume and spread of data in order to produce statistically significant results. It will be appreciated by those skilled in the art that access to such databases may be commercially available (e.g. RP Data).

The database 114 can contain historical marketing and/or sales data for real estate properties that have either been sold, or for which sale has, or is currently, being attempted. For each of such properties, the database may also contain specific advertising data relating to that property including, but not limited to, advertisement mediums (e.g. print, online etc.), features of advertisement such as size (e.g. ½ a page), advertisement placement (e.g. middle, top, bottom), advertisement presence, and number of photographs used in advertisement. In order to ensure the currency of the marketing campaign analysis, it is expected that the database 114 can be regularly updated to include data from recent property listings and/or sales. Furthermore, it is preferable that the database 114 may contain at least 12 months of relevant marketing and sales data so that any seasonal effects can be identified in conducting the marketing campaign analysis. An example of a listings table from a suitable database is shown below in Table 1.

TABLE 1

| | | | | Prop. | | Sold | Date first | First | | Sale |
|---|---|---|---|---|---|---|---|---|---|---|
| LinkID | Suburb | State | Post | Type | Sold Date | Price | listed | Listing Price | Combination | Status |
| 2 | GUNGAHLIN | ACT | 2912 | house | 28 Apr. 2010 | 465000 | 31 Mar. 2010 | 479000 | Canberra times, | SOLD |
| | | | | | | | | | Realestate.com.au | |

For convenience, and for assisting with data handling, a representative embodiment of the present invention may also include assigning a unique combination code to each combination of advertising media. For example, real estate properties that were only advertised in the Can berra Times and on realestate.com.au, could be assigned a unique combination code of 2287.

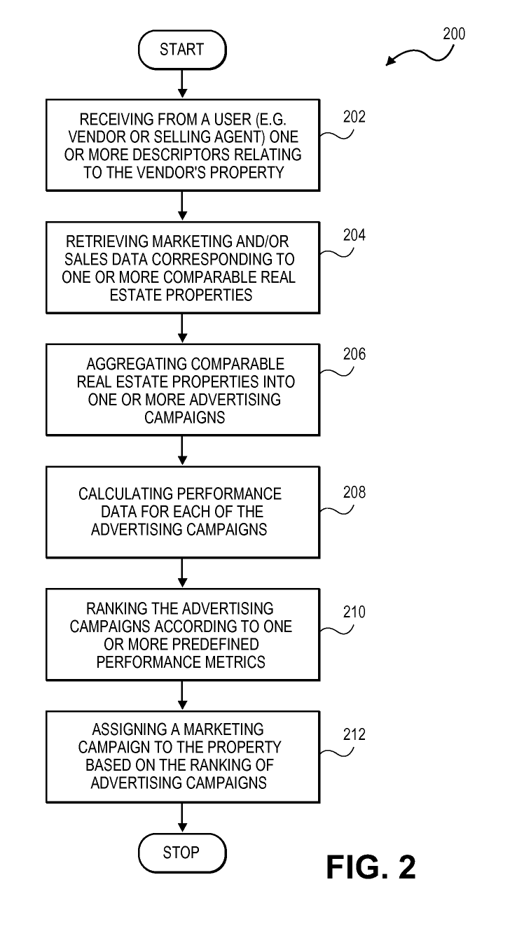

FIG. 2 is a flow chart 200 which illustrates an example method of optimizing a marketing campaign of a real estate property in accordance with an embodiment of the present invention. In line with this general method, at least steps 202 to 210 represent steps that could be performed by the selling agent prior to the initial meeting with the vendor, as they do not require any significant input from the vendor (other than general descriptor information which is likely to be publicly available). However, it should be understood that the method according to the embodiment of the present invention can also be performed without a meeting between the vendor and the real estate agent or, alternatively, that certain parts of the method may be performed in advance and a marketing analysis report generated and presented to the vendor (either electronically or in person).

At step 202, the method includes receiving from a user, one or more descriptors relating to the vendor's property. In a representative embodiment of the present invention, the descriptors include at least the geographical region in which the vendor's property is located, such as the street, suburb, and/or state in which the property is located, depending on the level of specificity required for the marketing campaign analysis. The descriptors may also include a property type classification for the vendor's property (e.g. house, apartment, unit, villa, and land).

Depending on the way in which the marketing campaign analysis is conducted, the descriptors may be provided by either the vendor or the real estate agent. If the real estate agent has been contacted in advance by the vendor, and is aware of the location and property type classification of the vendor's property, then this information can be input by the real estate agent directly into the marketing campaign analysis application (from their personal computer or remotely using a mobile device, such as an iPad). Similarly, if the real estate agent is meeting with the vendor for the first time, then this information can be extracted from the vendor. Alternatively, the real estate agent may be able to access this information about the property from a database, such as the property information database operated by RP Data or from database 114. In a representative embodiment of the present invention, the marketing campaign analysis and recommendations are produced using an application on an Apple iPad, or similar smart computing device, that has a wireless connection to the Internet. Alternatively, if step 202 of the method is performed by electronic form completion (i.e. an electronic form completed by the vendor, preferably with the vendor's initial enquiry to the real estate agent) then this information would be provided by the vendor.

At step 204, the method involves retrieving, from the database 114, marketing data and sales data corresponding to comparable real estate properties. In order to retrieve this data, a determination can firstly be made concerning which properties constitute comparable real estate properties. As an initial step, the method may use the descriptors (i.e. the geographical location and/or property type classification) to query the database 114 and identify those real estate properties having one or more of the same descriptors. For example, if a vendor's property is located in the suburb of Gungahlin, then comparable real estate properties can include all those properties located in the suburb Gungahlin. Similarly, if a vendor's property is an apartment (or, more specifically, a 2-bedroom apartment), then comparable real estate properties may include all those properties that have an ‘apartment’ property type classification (or 2-bedroom apartment sub-classification). It should be appreciated that multiple descriptors can be used in order to refine the pool of comparable real estate properties identified in the database 114. For example, if the vendor's property is an apartment located in the suburb of Gungahlin, then comparable real estate properties can include all those properties located in the suburb of Gungahlin that have an ‘apartment’ property type classification. By using multiple descriptors, it is possible to identify those real estate properties which are most closely correlated to the vendor's property.

Once the comparable real estate properties have been identified from within the database 114, the method (at step 204) retrieves the marketing data and/or sales data corresponding to each of these comparable real estate properties. This marketing data may include, for each of the comparable real estate properties, at least the advertising selections (i.e. the advertising sources) used to advertise the property, as well as the initial listing price for the property, and the date upon which the property was first listed for sale. An example of this marketing data is shown in Table 1 above where the advertising sources, listed under the ‘Combination’ heading, include the Can berra Times and realestate.com.au. However, and as previously indicated, this information could be replaced by a unique combination code used to represent a given combination of one or more advertising sources. For example, real estate properties that were only advertised in the Can berra Times and on realestate.com.au, could be assigned a unique combination code of 2287. It is also evident from the example in Table 1 that the initial or ‘first listing price’ is shown as $479,000, and that the first listing date is shown as 31 Mar. 2010.

In addition to the marketing data, the method (at step 204) also retrieves sales data for all or some of the comparable real estate properties. For some of these comparable real estate properties, which are either currently on the market or for which a sale was not completed, it may not be possible to retrieve sales data. However, for all other comparable real estate properties, such sales data should be available from the database 114. This sales data includes at least a final sale price at which the comparable real estate property was sold, and the date on which the property was sold (i.e. the ‘sold date’). An example of this sales data is shown in Table 1 above, where the final sale price or ‘sold price’ is shown as $465,000, and the ‘sold date’ is shown as 28 Apr. 2010. Further sales data that may be extracted from the database include the sale status (e.g. sold, sale pending).

As an additional step, performed either during step 204 or at an earlier stage, the method may also allow the user to limit the number of comparable real estate properties identified by specifying a time period or date range. For example, and as a result of constant market fluctuations and sales trends, a user (e.g. a real estate agent and/or vendor) may only wish to identify comparable market properties that were listed for sale within the preceding two years. By refining the pool of comparable real estate properties in this manner, it is expected that the currency of the data can be preserved, and the final marketing campaign analysis may be more accurate, and thus the recommendations more useful to the vendor.

After retrieving all available marketing and sales data from the database 114, the method (at step 206) performs an aggregation or grouping of the comparable real estate properties into one or more advertising campaigns, based upon the advertising selections used in the advertising of each of these properties. The criterion for grouping the comparable real estate properties into advertising campaigns can be the specific combinations of advertising selections. For example, all comparable real estate properties having advertising sources listed, under the ‘Combination’ heading in Table 1, as only Can berra Times and realestate.com.au (or having a unique combination code of 2287), could be grouped into advertising campaign. Similarly, and also by way of example, all comparable real estate properties having advertising sources listed as only Mosman Daily and Sydney Morning Herald, could be grouped into a further advertising campaign. It is also preferable that each of the advertising campaigns, and associated comparable real estate properties, may be stored in the database 114 so as to facilitate further calculations and manipulation of the marketing and sales data.

Once the comparable real estate properties have been grouped into advertising campaigns, according to their advertising selections, the number of comparable real estate properties within each advertising campaign can be calculated. Advertising campaigns having less than a predetermined number of comparable real estate properties may be disregarded from any further consideration, as a statistically significant number of properties may be required in order to ensure the accuracy and reliability of subsequent analysis and recommendations.

Following the grouping of the comparable real estate properties into respective advertising campaigns, the method (at step 208) then involves the calculation of performance data for each of the comparable real estate properties using the available marketing and sales data. For each of the advertising campaigns, having statistically significant numbers of comparable real estate properties, the following performance data may generated:

(a) Sales success rate—which is calculated (as a percentage) by comparing the total number of comparable real estate properties sold, to the total number of comparable real estate properties advertised;

(b) Frequency of advertising formats—which is calculated by totaling the number of comparable real estate properties within the advertising campaign and/or totaling the numbers of comparable real estate properties within the advertising campaign that use a specific advertising format (e.g. ¼ page color advertisement);

(c) Average time on market prior to sale—which includes firstly calculating, for each of the comparable real estate properties (where sales data is available), the number of days between the initial listing date (taken from the marketing data) and the final sale date (taken from the sales data) and, secondly, calculating the average number of days on the market for the comparable real estate properties within the advertising campaign; and

(d) Average vendor discount of initial listing price relative to final sale price—which includes firstly calculating, for each of the comparable real estate properties (where sales data is available), the percentage discount (or premium) of the initial listing price (taken from the marketing data) by referring to the final sale price (taken from the sales data) and, secondly, calculating the average vendor discount for the comparable real estate properties within the advertising campaign.

The calculated performance data is then stored within the database 114 to enable the subsequent ranking of the advertising campaigns. An example of how this performance data (in this instance, average time on market prior to sale, and average vendor discount) might be stored in the listings table of the database 114 is shown below in Table 2.

TABLE 2

| | Sold | Date first | | First | | Sale | Days on | Vendor |
|---|---|---|---|---|---|---|---|---|
| LinkID | Price | listed | Sold Date | Listing Price | Combination | Status | the market | discount % |
| 2 | 465000 | 31 Mar. 2010 | 28 Apr. 2010 | 479000 | 2287 | SOLD | 28 | 3 |

After the performance data has been generated for each of the advertising campaigns, it is then possible (at step 210 of the method) to rank the success of the advertising campaigns according to certain predefined performance metrics. These performance metrics can include one or more of the highest sales success rate, the least vendor discount on initial listing price (relative to final sale price), most popular advertising campaign, and the least time on market prior to sale. The ranking of the advertising campaigns can be performed relatively simply based upon the calculated performance data for each of the advertising campaigns. It should be appreciated that additional performance metrics could also be used to rank the advertising campaigns, and that one or more or more of the above described performance metrics could be excluded (when conducted a marketing campaign analysis for given real estate property) depending on the specific marketing campaign strategy desired by the real estate agent and/or vendor.

In addition to ranking the advertising campaigns, using the predefined performance metrics, the method preferably includes the further step of ranking the most popular advertising formats and/or features for each advertising source. In one embodiment of the present invention, the database 114 also contains advertising features data that is extracted from the marketing data for all comparable real estate properties that are used to populate the database 114. This advertising features data includes, for each advertising source (if data is available), information such as the most popular advertisement size, the most popular advertisement section, an indication of whether photos were used in the advertisement (and if so, the number of photos, and whether these photos were in color), whether the advertisement was exclusive, and whether the advertisement was premium. It should be appreciated that the advertising features data may include additional information depending on the saleable commodity being advertised for sale. However, an example of how this advertising features data might be stored in the listings table of the database 114 is shown below in Table 3.

TABLE 3

| | | Ad | Ad | Photo | Photo | | |
|---|---|---|---|---|---|---|---|
| LinkID | Publication | size | section | Color | Count | Exclusive | Premium |
| 2 | CANBERRA | small | middle | No | N/A | Yes | No |
| | TIMES | | | Photo | | | |
| 2 | Realestate.com.au | n/a | n/a | Color | multiple | unknown | yes |

Based upon the advertising features data, it can then be possible to generate certain statistical information. For example, and as shown from the advertising features data in Table 3 above, if the vendor's property is a ‘house’ located in Gungahlin, then the following statistical statements could be generated (for possible inclusion in a marketing analysis report):

“The most popular advertisement for the ‘Can berra Times’ is a small advertisement, in the middle section, without photographs.”

“The most popular advertisement for ‘realestate.com.au. is a premium listing with multiple colour photographs.”

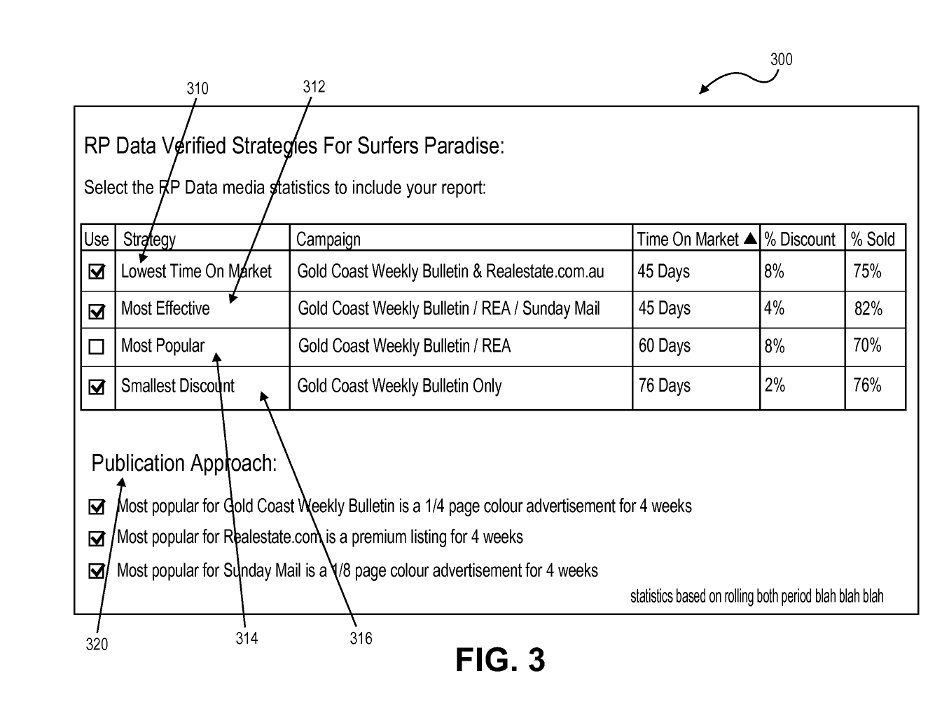

The final step of the method, shown at step 212, involves assigning a marketing campaign to the vendor's property, including the specific advertising campaign that can be used to advertise the property. Ideally, the decision regarding the marketing campaign is made by agreement between the vendor and the real estate agent. After the ranking of the advertising campaigns, at step 210, the real estate agent can then generate a marketing analysis and recommendations report, which can then be presented to the vendor either in person or electronically. By accessing the marketing campaign analysis application, either from a personal computer or remotely using a mobile device (e.g. iPad), the real estate agent will be presented with a report generation screen 300, shown in FIG. 3. From this screen 300, the real estate agent may be able select the performance metric rankings to include in the final marketing analysis and recommendations report to the vendor. For example, and as shown in FIG. 3, the real estate agent has been presented with options to include performance metric rankings (termed ‘Strategies) for ‘Lowest time on market’ 310, ‘Most effective’ 312, ‘Most popular’ 314, and ‘Smallest discount’ 316, although the agent has made the decision not to include the performance metric ranking for ‘Most popular’ 314 advertising campaign. Once the selections have been finalized by the real estate agent, the marketing campaign analysis and recommendations report can be generated, showing the performance data (e.g. time on market, vendor discount, and sales success rate) for the top ranking advertising campaign in each performance metric.

In addition to the performance metric rankings, the real estate agent can have the option from screen 300 (under the ‘Publication Approach’ heading 320) to include statistical information regarding the most popular advertising formats and/or features for each advertising source. For example, and as shown in FIG. 3, the real estate agent has been presented with options to include the following information:

“Most popular for Gold Coast Weekly Bulletin is a ¼ page colour advertisement for 4 weeks”;

“Most popular for Realestate.com.au is a premium listing for 4 weeks”; and

“Most popular for Sunday Mail is a ⅛ page colour advertisement for 4 weeks”.

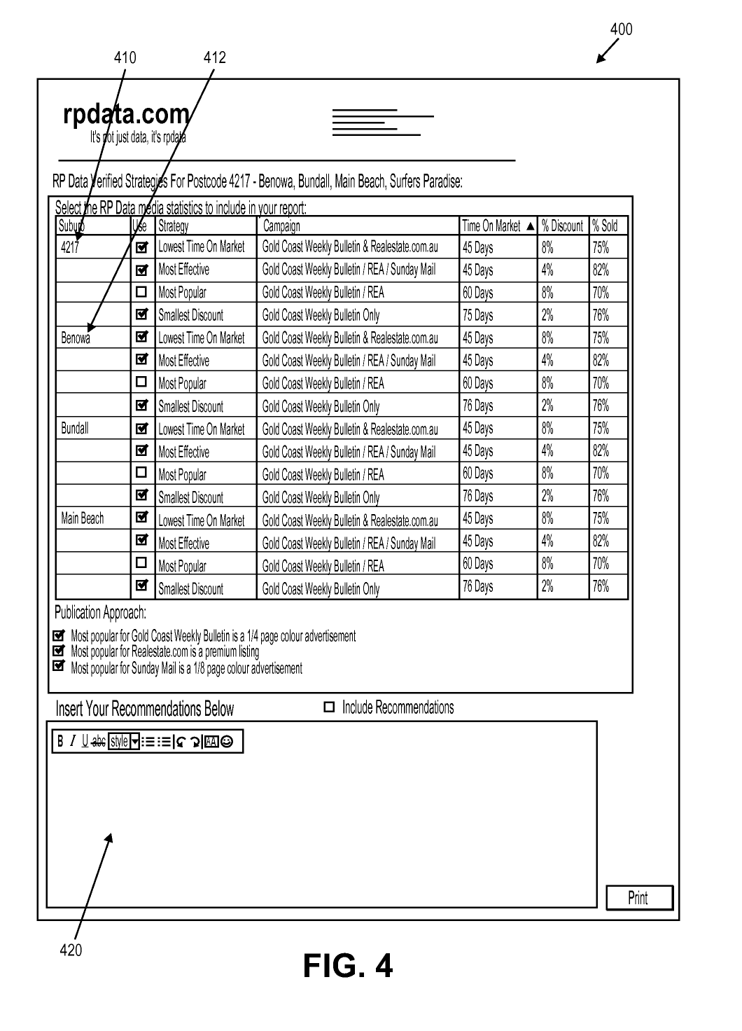

In an alternative embodiment of the present invention, the real estate agent may be presented with a multi-locational report generation screen 400, as shown in FIG. 4. From this screen 400, the real estate agent may be able select the performance metric rankings to include in the final marketing analysis and recommendations report, in much the same manner as screen 300. However, screen 400 can allow the agent to select the performance metric rankings for one or more postcodes 410 and/or suburbs 412 that are of relevance to the vendor's property. In addition, screen 400 may also allow the agent to input specific written recommendations 420, preferably in relation to recommended marketing campaigns, which will also appear on the marketing campaign analysis and recommendations report. Once the selections and comments have been finalized by the real estate agent, the marketing campaign analysis and recommendations report can be generated, showing the performance data (e.g. time on market, vendor discount, and sales success rate) for the top ranking advertising campaign in each performance metric, and for each postcode 410 and/or suburb 412 selected.

Based upon the options selected by the real estate agent (and/or vendor) at screen 300 and/or screen 400, a marketing campaign analysis and recommendations report can be generated and presented to the vendor. Depending on the strategy (i.e. ‘Lowest time on market’, ‘Most effective’, ‘Most popular’, and ‘Smallest discount’) agreed upon between the vendor and the real estate agent, an appropriate marketing campaign can be selected for the vendor's property. While the selected marketing campaign may specify the preferred advertising selections to be used (e.g. Can berra Times and realestate.com.au) in the advertising campaign, it should be appreciated that additional advertising selections may also be added or removed from the marketing campaign. For example, and based on the information shown on screen 300 in FIG. 3, if the strategy selected by the vendor (and/or real estate agent) is ‘Lowest time on market’, then the recommended advertising selections are Gold Coast Weekly Bulletin and realestate.com.au.

If the presentation to the vendor has gone successfully, and the vendor is satisfied with the marketing campaign recommendations in the report, the agent may assist the vendor to complete an electronic ‘Authority to Act’ document so as to give the agent an exclusive agency agreement for an agreed period of time. This may involve the confirmation of the marketing campaign to be used in the sale of the vendor's property, as well as the specific advertising selections and advertising formats. Part of this process may also involve the vendor confirming a minimum listing value for the property.

As embodiments of the present invention may be embodied in several forms without departing from the characteristics of the embodiments, it should be understood that the above described embodiments should not be considered to limit but rather should be construed broadly. Various modifications, improvements and equivalent arrangements will be readily apparent to those skilled in the art, and are intended to be included within the spirit and scope of the invention.

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as database 114, relational databases and flat file systems that use magnetic disk storage and/or solid state RAM. Some or all of the components shown in FIG. 1, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A computer-implemented method of optimizing a marketing campaign of a saleable commodity, said method comprising:
(a) receiving from a user one or more descriptors relating to said saleable commodity;
(b) identifying, based at least in part on said one or more descriptors, one or more comparable saleable commodities for which marketing has been conducted;
(c) retrieving, by a computing system comprising one or more processors, marketing data corresponding to said one or more comparable saleable commodities, said marketing data including advertising selections used in the sale or attempted sale of said one or more comparable saleable commodities;
(d) aggregating, by the computing system, said one or more comparable saleable commodities into one or more advertising campaigns based at least in part upon said advertising selections;
(e) calculating, by the computing system for each of said one or more advertising campaigns, performance data based at least in part upon said marketing data;
(f) ranking, by the computing system based at least in part on said performance data, success of said one more advertising campaigns according to one or more predefined performance metrics; and
(g) assigning a marketing campaign to said saleable commodity based at least in part on the ranking of said one more advertising campaigns, said marketing campaign including a selection of said advertising selections.

2. The method according to claim 1, wherein said saleable commodity is a real estate property and said one or more comparable saleable commodities are comparable real estate properties.

3. The method according to claim 2, wherein said one or more descriptors includes at least a geographical region in which the real estate property is located.

4. The method according to claim 3, wherein said geographical region includes one or more of:
(a) a street in which the real estate property is located;
(b) a suburb in which the real estate property is located; and
(c) a state in which the real estate property is located.

5. The method according claim 3, wherein said one or more descriptors also includes a property type classification.

6. The method according to claim 2, wherein for each of said comparable real estate properties said marketing data includes one or more of:
(a) an initial listing price for said comparable real estate property;
(b) a date on which said comparable real estate property was first listed; and
(c) advertising selections used in the sale or attempted sale of said comparable real estate property, including one or more of:
(i) a specific print medium used to advertise said comparable real estate property;
(ii) a specific radio medium used to advertise said comparable real estate property;
(iii) a specific television medium used to advertise said comparable real estate property; and
(iv) a specific online medium used to advertise said comparable real estate property.

7. The method according to claim 2, wherein said one or more advertising campaigns comprise individual advertising selections or combinations of advertising selections.

8. The method according to claim 2, wherein for each of said comparable real estate properties said sales data includes one or more of:
(a) a final sale price at which said comparable real estate property was sold;
(b) a date on which said comparable real estate property was sold; and
(c) a sale status for said comparable real estate property.

9. The method according to claim 2, wherein said performance data includes one or more of:
(a) sales success rate for each of said one or more advertising campaigns;
(b) frequency of advertising campaigns;
(c) average time on market prior to sale; and
(d) average vendor discount of initial listing price relative to final sale price.

10. The method according to claim 9, further including the step of ranking for each of said one or more advertising campaigns the most popular advertising format.

11. The method according to claim 2, wherein said predefined performance metrics include one or more of:
(a) highest sales success rate;
(b) least time on market prior to sale;
(c) most popular advertising campaign; and
(d) least vendor discount on initial listing price relative to final sale price;

12. The method according to claim 9, wherein step (g) includes a preliminary step of presenting to said user one or more marketing campaigns in relation to listing said real estate property for sale.

13. The method according to claim 2, further including the step of assigning a listing value to said real estate property based on the ranking of said one more advertising campaigns.

14. The method according to claim 2, further including the step of receiving from a vendor an authority to list said real estate property for sale, said authority to list including confirmation of a selected marketing campaign offer or a listing price for said real estate property.

15. A computer-implemented system of optimizing a marketing campaign of a saleable commodity, said system comprising one or more computers including:
at least one processor;
an interface between said processor and a data network;
a database for containing information relating to said saleable commodity; and
at least one storage medium operatively coupled to said processor, said storage medium containing program instructions for execution by said at least one processor, said program instructions causing said at least one processor to execute the steps of:
(a) receiving from a user one or more descriptors relating to said saleable commodity;
(b) identifying, based at least in part on said one or more descriptors, one or more comparable saleable commodities for which marketing has been conducted;
(c) retrieving from said database marketing data corresponding to said one or more comparable saleable commodities, said marketing data including advertising selections used in the sale or attempted sale of said one or more comparable saleable commodities;
(d) aggregating said one or more comparable saleable commodities into one or more advertising campaigns based at least in part upon said advertising selections;
(e) calculating for each of said one or more advertising campaigns performance data based at least in part upon said marketing data;
(f) ranking, based at least in part on said performance data, success of said one more advertising campaigns according to one or more predefined performance metrics;
(g) storing in said database information relating to said saleable commodity, said one or more comparable saleable commodities, or said rank of said one or more advertising campaigns; and
(h) assigning a marketing campaign to said saleable commodity based on the ranking of said one more advertising campaigns, said marketing campaign including a selection of said advertising selections.

16. The computer-implemented system according to claim 15, wherein said saleable commodity is a real estate property and said one or more comparable saleable commodities are comparable real estate properties.

17. The computer-implemented system according to claim 16, wherein said program instructions further cause the at least one processor, in step (c) to retrieve said marketing data corresponding to said one or more comparable real estate properties via said data network.

18. The computer-implemented system according to claim 16, wherein said program instructions further cause the at least one processor, in step (f) to enable said user to select the predefined performance metrics that will be used to rank the success of said one or more advertising campaigns.

19. The computer-implemented system according to claim 16, wherein said program instructions further cause the at least one processor, in step (h) to present to said user in a graphical format, one or more of:
(a) details of at least the top ranked advertising campaign for each of said performance metrics identified in step (f); and
(b) possible marketing campaigns together with a selection of advertising selections for each of said marketing campaigns.

20. A tangible computer-readable medium having computer-executable instructions stored thereon for performing a method of optimizing a marketing campaign of a saleable commodity, said method comprising:
(a) receiving from a user one or more descriptors relating to said saleable commodity;
(b) identifying, based at least in part on said one or more descriptors, one or more comparable saleable commodities for which marketing has been conducted;
(c) retrieving marketing data corresponding to said one or more comparable saleable commodities, said marketing data including advertising selections used in the sale or attempted sale of said one or more comparable saleable commodities;
(d) aggregating said one or more comparable saleable commodities into one or more advertising campaigns based at least in part upon said advertising selections;
(e) calculating for each of said one or more advertising campaigns performance data based at least in part upon said marketing data;
(f) ranking, based at least in part on said performance data, success of said one more advertising campaigns according to one or more predefined performance metrics; and
(g) assigning a marketing campaign to said saleable commodity based at least in part on the ranking of said one more advertising campaigns, said marketing campaign including a selection of said advertising selections.

21. A computer-implemented method of optimizing a marketing campaign for the sale of a residential property, said method comprising:
(a) receiving one or more descriptors relating to the residential property;
(b) identifying, based at least in part on said one or more descriptors, at least one comparable residential property for which marketing to sell said at least one comparable residential property has been conducted;
(c) retrieving historical marketing data and sales data corresponding to each comparable residential property, said marketing data including advertising selections used in the sale or attempted sale of said at least one comparable residential property; and
(d) identifying, using said marketing data and sales data, the most effective advertising campaign for said residential property.
